(19) United States
(12) Patent Application Publication
(10) Pub. No.: US 2012/0121059 A1
(43) Pub. Date: May 17, 2012

(54) SYSTEM FOR MEASURING THE FREQUENCY OF A VIBRATING WIRE SENSOR USING A DIGITAL COUNTER SYSTEM

(75) Inventor: JongMoon Kim, Seoul (KR)

(73) Assignee: DS TEK CO., INC, Seoul (KR)

(21) Appl. No.: 13/376,521

(22) PCT Filed: Jul. 2, 2010
(86) PCT No.: PCT/KR2010/004304

§ 371 Date: Dec. 6, 2011

(30) Foreign Application Priority Data
Jul. 14, 2009 (KR) 10-2009-0064118

(51) Int. Cl. G01H 13/00

(52) U.S. Cl. 377/19

(57) ABSTRACT

The present invention relates to a system for measuring the frequency of a vibrating wire sensor using a digital counter system, which measures changes in the length of a structure to monitor changes in the structure, comprising: a processor which outputs an excitation signal to an excitation signal interface unit for a vibrating wire sensor, and compares the counted value input from an external source with a consumed time to calculate a resonant frequency; said excitation signal interface unit for a vibrating wire sensor, which receives the excitation signal from the processor, converts the received signal into a form capable of generating an excitation, and outputs the converted signal; said vibrating wire sensor, which outputs an intrinsic vibration signal in response to the excitation signal; a received signal interface unit for the vibrating wire sensor, which receives an intrinsic vibration signal output by the vibrating wire sensor, converts the received signal into a signal recognizable by the processor, and outputs the converted signal to the processor; a signal-converting unit which converts the amplified intrinsic vibration signal into a digital signal; and a counter which counts the digital intrinsic vibration signal output from the signal converting unit and outputs the counted value to the processor.

### TECHNICAL FIELD

The present invention relates to a system for measuring a frequency of a vibrating wire sensor using a digital counter. More specifically, the present invention relates to a system for measuring a frequency of a vibrating wire sensor using a digital counter for monitoring variation of a structure through measurement of changes in the length of the structure.

### BACKGROUND ART

With development of technology, building and civil engineering structures are becoming increasingly complex and large in scale. Thus, it is becomingly important to monitor security of such structures.

A variety of sensors are used to monitor security of buildings and civil engineering structures. A vibrating wire sensor is one example of such sensors.

A vibrating wire sensor is used in various fields to measure changes in the length of a structure. In addition to the vibrating wire sensor, an optical cable is used to measure changes in the length of a structure. However, a monitoring system based on an optical cable has a complex structure, suffers from installation difficulty, and requires expensive equipment. Thus, systems based on an optical cable are not generally adopted in the art.

On the contrary, the vibrating wire sensor may be used in association with a simple measurement instrument. Currently, a measurement instrument based on analog-to-digital converter is widely used for the vibrating wire sensor.

When the vibrating wire sensor including a vibrating wire is excited, the sensor outputs a signal corresponding to an intrinsic frequency of vibration of the wire. Here, since the output signal has an analog value, an analog-to-digital converter is used to convert the analog signal into a digital signal to be read by a processor.

The processor calculates the intrinsic frequency of the vibrating wire by combining the read inherent vibration output with time.

Generally, the analog-to-digital converter is used when employing such a vibrating wire sensor for measuring changes of a structure. Since this manner requires continuous sampling of analog outputs corresponding to the intrinsic vibration signals output from the vibrating wire, the processor inevitably undergoes heavy data processing burden.

FIG. 1 shows one example of a conventional system for measuring a frequency of a vibrating wire sensor, which includes a typical vibrating wire sensor 12 and a measurement instrument 11. In FIG. 1, the system includes the measurement instrument 11 and the vibrating wire sensor 12. The measurement instrument 11 outputs an excitation signal to the vibrating wire sensor 12, which in turn outputs an intrinsic vibrating signal in response to the excitation signal. Then, the measurement instrument 11 recognizes variation of a structure based on calculation of the intrinsic vibrating signal sent from the vibrating wire sensor 12.

FIG. 2 shows another example of a conventional system for measuring a frequency of a vibrating wire sensor. In FIG. 2, the system includes a processor 21 which outputs an excitation signal to the excitation signal interface unit 23 for a vibrating wire sensor described below and calculates the intrinsic frequency of vibration in response to the excitation signal by comparing the intrinsic vibration signal received from the excitation signal interface unit 23 with consumed time, an excitation signal interface unit 23 which receives the excitation signal output from the processor 21, converts the signal into a signal capable of exciting the sensor and outputs the converted signal to the sensor, a vibrating wire sensor 22 which outputs the intrinsic vibration signal in response to the excitation signal, and a received signal interface unit 24 for the vibrating wire sensor, which receives the intrinsic vibration signal output from the vibrating wire sensor 22, converts the intrinsic vibration signal into a signal capable of being recognized by the processor 21, and outputs the converted signal to the processor 21.

Unlike the system shown in FIG. 1, this system includes the interface units 23, 24 between the processor 21 and the vibrating wire sensor 22. In this system, the excitation signal interface unit 23 receives an excitation signal sent from the processor 21, converts the signal into a signal capable of exciting the vibrating wire sensor 22, and outputs the converted signal to the vibrating wire sensor 22. Then, the vibrating wire sensor 22 is excited and outputs an intrinsic vibration signal. The intrinsic vibration signal is converted into a signal capable of being recognized by the processor 21 through the received signal interface unit 24 for the vibrating wire sensor and is input to the processor 21. Then, the processor 21 recognizes variation of a structure by changing the intrinsic vibration signal to a resonance frequency through comparison with consumed time.

FIG. 3 shows still another example of a conventional system for measuring a frequency of a vibration wire sensor, in which a signal is excited in a similar manner to the system shown in FIG. 2.

As shown in FIG. 3, the system for measuring a frequency of a vibrating wire sensor includes a processor 31 which outputs an excitation signal to the excitation signal interface unit 33 for a vibrating wire sensor described below and calculates the intrinsic frequency of vibration in response to the excitation signal by comparing the intrinsic vibration signal received from the excitation signal interface unit 33 with consumed time, an excitation signal interface unit 33 which receives the excitation signal output from the processor 31, converts the signal into a signal capable of exciting the vibrating wire sensor and outputs the converted signal to the vibrating wire sensor, a vibrating wire sensor 32 which outputs an intrinsic vibration signal in response to the excitation signal, a received signal interface unit 34 for the vibrating wire sensor, which outputs the intrinsic vibration signal sent from the vibrating wire sensor 32 through amplification of the intrinsic vibration signal, and an analog-to-digital signal converter 35 which converts the signal received from the received signal interface unit 34 into a digital signal and outputs the converted digital signal to the processor 21.

In the system for measuring the frequency of a vibrating wire sensor shown in FIG. 3, an excitation signal is generated through the excitation signal interface unit 32 for the vibrating wire sensor under control of the processor 31. Then, the vibrating wire sensor 32 outputs the intrinsic vibration signal to the received signal interface unit 34 for the vibrating wire sensor in response to the excitation signal.

The received signal interface unit 34 amplifies the intrinsic vibration signal sent from the vibrating wire sensor 32 and outputs the amplified signal to the analog-to-digital converter 35, which in turn converts the analog inherent vibration signal into a digital inherent vibration signal and outputs the digital inherent vibration signal to the processor 31.

Then, the processor 31 calculates the intrinsic frequency of vibration of the vibrating wire sensor 32 based on the digital inherent vibration signal, and recognizes variation of a structure.

As such, in order to employ the vibrating wire sensor for measuring changes of a structure, an analog-to-digital converter is generally used. In this case, since it is necessary to perform consistent sampling of analog outputs corresponding to the intrinsic vibration signals output from the vibrating wire, the processor inevitably undergoes heavy data processing burden. Moreover, since a wireless system established using such a vibrating wire sensor consumes large amounts of power, it is inconvenient in terms of management due to frequent replacement of batteries when common batteries are used to supply power for operation.

### DISCLOSURE

### Technical Problem

The present invention is conceived to solve the problems of the related art, and the present invention is directed to providing a system for measuring a frequency of a vibrating wire sensor using a digital counter for monitoring changes of a structure through measurement of variation in the length of the structure.

That is, the present invention is directed to providing a system for measuring a frequency of a vibrating wire sensor, which may measure the intrinsic frequency of vibration through conversion of an analog output into a digital output and calculation of the number of digital output waves using the counter system, thereby reducing processor burden. As a result, the system reduces processor burden, thereby enabling reduction of power consumption.

The present invention is also directed to providing a system for measuring a frequency of a vibrating wire sensor using a digital counter, which may convert an analog output into a digital output not only to reduce processor burden through elimination of an analog-to-digital converter, but also to reduce complexity of a circuit configuration, such that power consumed by a measurement instrument of the vibrating wire sensor can be reduced, thereby facilitating establishment of a wireless remote monitoring system using the vibrating wire sensor.

That is, the present invention is directed to providing a system for measuring a frequency of a vibrating wire sensor, which permits the measurement instrument of the vibrating wire sensor to be operated using a commercially available battery for at least one year.

### Technical Solution

In accordance with one aspect of the invention, a system for measuring a frequency of a vibrating wire sensor using a digital counter includes: a processor which outputs an excitation signal to the excitation signal interface unit for the vibrating wire sensor and compares a counted value input from an external source with consumed time to calculate a resonant frequency; an excitation signal interface unit for the vibrating wire sensor, which receives the excitation signal from the processor, converts the received signal into a signal capable of exciting the vibrating wire sensor, and outputs the converted signal; an excitation signal interface unit for the vibrating wire sensor, which receives the excitation signal from the processor, converts the received signal into a signal capable of exciting the vibrating wire sensor, and outputs the converted signal; a vibrating wire sensor which outputs an intrinsic vibration signal in response to the excitation signal; a received signal interface unit for a vibrating wire sensor, which receives the intrinsic vibration signal output from the vibrating wire sensor, converts the received signal into a signal recognizable by the processor, and outputs the converted signal to the processor; a signal converting unit which converts an amplified intrinsic vibration signal into a digital intrinsic vibration signal; and a counter which counts the number of digital intrinsic vibration signals output from the signal converting unit and outputs a counted value to the processor.

The signal converting unit may include a transistor or an OP amplifier.

In accordance with another aspect of the invention, a system for measuring a frequency of a vibrating wire sensor using a digital counter includes: a processor which outputs an excitation signal to the excitation signal interface unit for the vibrating wire sensor, counts the number of inherent digital vibration signals input from an external source in an interrupt manner, and compares a counted value with consumed time to calculate a resonant frequency; an excitation signal interface unit for the vibrating wire sensor, which receives the excitation signal from the processor, converts the received signal into a signal capable of exciting the vibrating wire sensor, and outputs the converted signal; a vibrating wire sensor which outputs an intrinsic vibration signal in response to the excitation signal; a received signal interface unit for the vibrating wire sensor, which receives the intrinsic vibration signal output from the vibrating wire sensor, converts the received signal into a signal recognizable by the processor, and outputs the converted signal to the processor; and a signal converting unit which converts an amplified intrinsic vibration signal into a digital signal and outputs the converted signal to the processor.

The signal converting unit may include a transistor or an OP amplifier.

The processor may include a separate interrupt circuit which counts the number of inherent digital vibration signals input from the external source in an interrupt manner and outputs the counted value.

### Advantageous Effects

The system according to the present invention enables a substantial reduction in calculations performed by a processor, as compared with a conventional system which employs an analog-to-digital converter.

Further, the system according to the present invention reduces processor power consumption and may eliminate a circuit of the analog-to-digital converter, thereby simplifying a circuit configuration and reducing power consumption.

Further, in installation of a wireless system for remote monitoring which has been recently used in the art, it is important to achieve reduction of power consumption of a measurement instrument placed at an installation site as much as possible, since large power consumption of the measurement instrument requires an external power source and thus makes it difficult to achieve a completely wireless system. Accordingly, the system according to the present invention may substantially reduce power consumption to realize a circuit configuration advantageously suited to a wireless system, thereby enabling size reduction.

### BRIEF DESCRIPTION OF THE DRAWINGS

FIG. 1 is a diagram of a general system for measuring a frequency of a vibrating wire sensor;

FIG. 2 is a diagram of another general system for measuring a frequency of a vibrating wire sensor;

FIG. 3 is a diagram of a conventional system for measuring a frequency of a vibrating wire sensor;

FIG. 4 is a diagram of a system for measuring a frequency of a vibrating wire sensor according to one embodiment of the present invention; and

FIG. 5 is a diagram of a system for measuring a frequency of a vibrating wire sensor according to another embodiment of the present invention, which includes a processor operating in an interrupt manner.

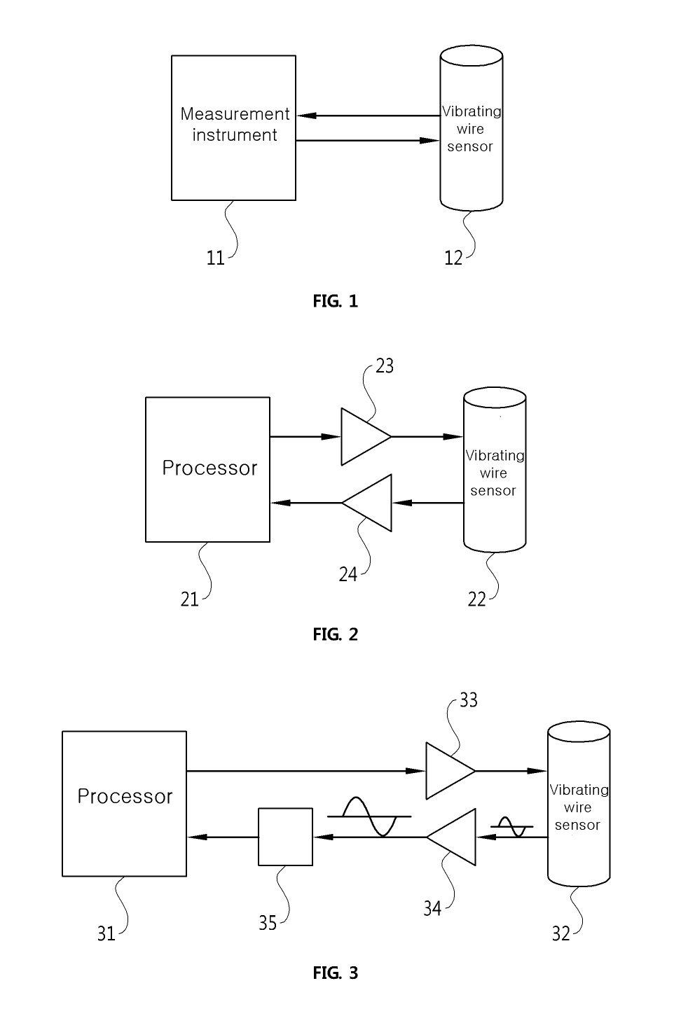

### DESCRIPTION OF REFERENCE NUMERALS OF THE DRAWINGS

11: Measurement instrument for vibrating wire sensor
12: Vibrating wire sensor
21: Processor
22: Vibrating wire sensor
23: Excitation signal interface for vibrating wire sensor
24: Received signal interface for vibrating wire sensor
31: Processor
32: Vibrating wire sensor
33: Excitation signal interface for vibrating wire sensor
34: Received signal interface for vibrating wire sensor
35: Analog-to-digital converter
41: Processor
42: Vibrating wire sensor
43: Excitation signal interface for vibrating wire sensor
44: Received signal interface for vibrating wire sensor
45: Transistor
46: Designated counter
51: Processor
52: Vibrating wire sensor
53: Excitation signal interface for vibrating wire sensor
64: Received signal interface for vibrating wire sensor
55: Transistor

### BEST MODE

Next, embodiments of the present invention will be described with reference to the accompanying drawings.

### Example 1

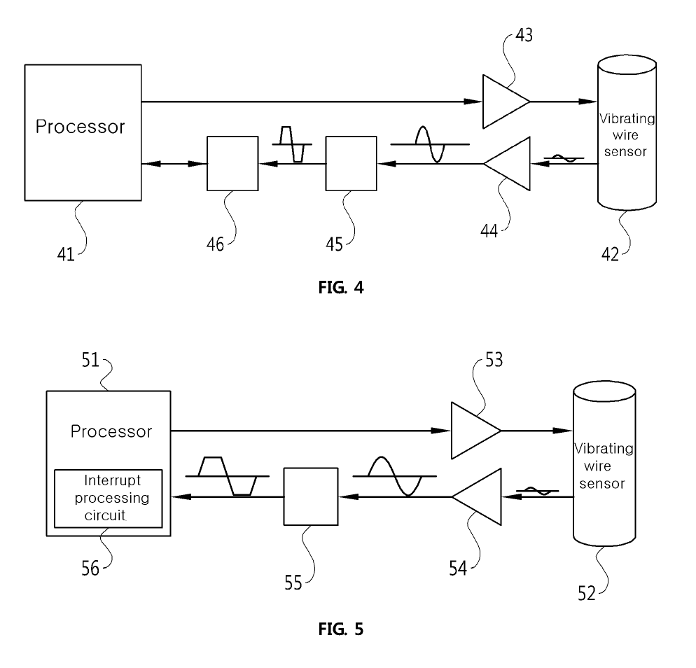

FIG. 4 is a diagram of a system for measuring a frequency of a vibrating wire sensor according to one embodiment of the present invention.

Referring to FIG. 4, the system for measuring a frequency of a vibrating wire sensor according to this embodiment includes a processor 41 which outputs an excitation signal to the excitation signal interface unit 43 for the vibrating wire sensor and compares a counted value with consumed time to calculate a resonant frequency; an excitation signal interface unit 43 for the vibrating wire sensor, which receives the excitation signal from the processor 41, converts the received signal into a signal capable of exciting the vibrating wire sensor, and outputs the converted signal; a vibrating wire sensor 42 which outputs an intrinsic vibration signal in response to the excitation signal; a received signal interface unit 44 for the vibrating wire sensor, which receives the intrinsic vibration signal output from the vibrating wire sensor 42, converts the received signal into a signal recognizable by the processor 41, and outputs the converted signal to the processor 41; a signal converting unit 45 which converts an amplified intrinsic vibration signal into a digital intrinsic vibration signal; and a counter 46 which counts the number of digital intrinsic vibration signals output from the signal converting unit 45 and outputs a counted value to the processor 41.

The signal converting unit 45 may include a transistor or an OP amplifier.

Next, operation of the system for measuring the frequency of the vibrating wire sensor according to this embodiment will be described.

As shown in FIG. 6, in the system for measuring the frequency of the vibrating wire sensor, the processor 41 outputs a control signal for generating an excitation signal to the excitation signal interface unit 43 for the vibrating wire sensor (S100), and the excitation signal interface unit 43 generates the excitation signal in response to the control signal for generating the excitation signal from the processor 41 and outputs the excitation signal to the vibrating wire sensor 42 (S110).

Then, the vibrating wire sensor 42 is excited by the excitation signal and outputs a low level of inherent vibration signal (S120), and the received signal interface unit 44 for the vibrating wire sensor amplifies the low level of inherent vibration signal and outputs the amplified signal to the signal converting unit 45 (S130).

Here, the signal converting unit 45 is constituted by a transistor, which is saturated with a predetermined amount of digital inherent vibration signals and through which the amplified inherent vibration signals are converted into digital inherent vibration signals.

The digital inherent vibration signals are input to the counter 46, which counts the number of digital inherent vibration signals input thereto and outputs a counted value to the processor 41 when counting a predetermined number of digital inherent vibration signals (S140).

Then, the processor 41 calculates the inherent frequency of vibration based on the counted value and recognizes changes of a structure (S150).

In FIG. 4, the system for measuring the frequency of the vibrating wire sensor according to this embodiment is realized without using an analog-to-digital converting circuit, and employs the transistor 45 to count the number of signals output from the excited vibrating wire sensor 42. Here, the processor may be realized using a single transistor or an OP amplifier. The OP amplifier may amplify a signal to be recognizable by the processor 41 when the signal has a predetermined intensity of more.

### Example 2

FIG. 5 is a diagram of a system for measuring a frequency of a vibrating wire sensor according to another embodiment of the present invention.

Referring to FIG. 5, the system for measuring a frequency of a vibrating wire sensor according to this embodiment includes a processor 51 which outputs an excitation signal to the excitation signal interface unit 53 for the vibrating wire sensor, counts the number of digital inherent vibration signals input from the signal converting unit 55 described below in an interrupt manner, and compares a counted value with consumed time to calculate a resonant frequency; an excitation signal interface unit 53 for the vibrating wire sensor, which receives the excitation signal from the processor 51, converts the received signal into a signal capable of exciting the vibrating wire sensor, and outputs the converted signal; a vibrating wire sensor 52 which outputs an intrinsic vibration signal in response to the excitation signal; a received signal interface unit 54 for the vibrating wire sensor, which receives the intrinsic vibration signal output from the vibrating wire sensor 52, converts the received signal into a signal recognizable by the processor 51, and outputs the converted signal to the processor 51; and a signal converting unit 55 which converts an amplified intrinsic vibration signal into a digital signal and outputs the converted signal to the processor 51.

Next, operation of the system for measuring the frequency of the vibrating wire sensor according to this embodiment will be described.

First, the processor 51 outputs a control signal for generating an excitation signal to the excitation signal interface unit 53 for the vibrating wire sensor, and the excitation signal interface unit 53 generates the excitation signal in response to the control signal for generating the excitation signal from the processor 51 and outputs the excitation signal to the vibrating wire sensor 52.

Then, the vibrating wire sensor 52 is excited by the excitation signal and outputs a low level of inherent vibration signal, and the received signal interface unit 54 for the vibrating wire sensor amplifies the low level of inherent vibration signal and outputs the amplified signal to the signal converting unit 55.

Here, the signal converting unit 55 is constituted by a transistor 55, which is saturated with a predetermined amount of digital inherent vibration signals and through which the amplified inherent vibration signals are converted into digital inherent vibration signals

The digital inherent vibration signals are input to the processor 51, and an interrupt processing circuit 56 in the processor counts the number of digital inherent vibration signals input thereto in an interrupt manner. Then, the processor 71 calculates the resonant frequency based on a counted value of the interrupt processing circuit 56.

In FIG. 5, the system for measuring the frequency of the vibrating wire sensor according to this embodiment is realized without using an analog-to-digital converting circuit and employs the transistor 55 to count the number of signals output from the excited vibrating wire sensor 52. Here, the processor may be realized using a single transistor or an OP amplifier. The OP amplifier may amplify a signal to be recognizable by the processor 51 when the signal has a predetermined intensity of more.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

1. A system for measuring a frequency of a vibrating wire sensor using a digital counter, comprising:
a processor which outputs an excitation signal to the excitation signal interface unit for the vibrating wire sensor and compares a counted value input from an external source with consumed time to calculate a resonant frequency;
an excitation signal interface unit for the vibrating wire sensor, which receives the excitation signal from the processor, converts the received signal into a signal capable of exciting the vibrating wire sensor, and outputs the converted signal;
a vibrating wire sensor which outputs an intrinsic vibration signal in response to the excitation signal;
a received signal interface unit for the vibrating wire sensor, which receives the intrinsic vibration signal output from the vibrating wire sensor, converts the received signal into a signal recognizable by the processor, and outputs the converted signal to the processor;
a signal converting unit which converts an amplified intrinsic vibration signal into a digital intrinsic vibration signal; and
a counter which counts the number of digital intrinsic vibration signals output from the signal converting unit and outputs a counted value to the processor.

2. The system of claim 1, wherein the signal converting unit comprises a transistor or an OP amplifier.

3. A system for measuring a frequency of a vibrating wire sensor using a digital counter, comprising:
a processor which outputs an excitation signal to the excitation signal interface unit for the vibrating wire sensor, counts the number of digital inherent vibration signals input from an external source in an interrupt manner, and compares a counted value with consumed time to calculate a resonant frequency;
an excitation signal interface unit for the vibrating wire sensor, which receives the excitation signal from the processor, converts the received signal into a signal capable of exciting the vibrating wire sensor, and outputs the converted signal;
a vibrating wire sensor which outputs an intrinsic vibration signal in response to the excitation signal;
a received signal interface unit for the vibrating wire sensor, which receives the intrinsic vibration signal output from the vibrating wire sensor, converts the received signal into a signal recognizable by the processor, and outputs the converted signal to the processor; and
a signal converting unit which converts an amplified intrinsic vibration signal into a digital signal and outputs the converted signal to the processor.

4. The system of claim 3, wherein the signal converting unit comprises a transistor or an OP amplifier.

5. The system of claim 1, wherein the processor comprises a separate interrupt processing circuit which counts the number of digital inherent vibration signals input from the external source in an interrupt manner and outputs the counted value.
